(19) United States
(12) Patent Application Publication
(10) Pub. No.: US 2026/0289827 A1
(43) Pub. Date: Sep. 24, 2026

(54) METHOD FOR PROCESSING SUBTITLE, DEVICE, AND STORAGE MEDIUM

(71) Applicant: Beijing Zitiao Network Technology Co., Ltd., Beijing (CN)

(72) Inventors: Jianfeng ZHANG, Beijing (CN); Dajun ZHAO, Beijing (CN); Yiming DAI, Beijing (CN); Daoyi ZHANG, Beijing (CN); Chengcai GAO, Beijing (CN); Cen XIONG, Beijing (CN); Yibo DAI, Beijing (CN)

(21) Appl. No.: 19/433,215

(22) Filed: Dec. 26, 2025

(30) Foreign Application Priority Data
Mar. 21, 2025 (CN) 202510344801.8

(51) Int. Cl. G06T 11/00

(52) U.S. Cl. CPC G06T 11/00

(57) ABSTRACT

The present disclosure provides a method for processing subtitle, a terminal device, and a storage medium. The method includes: determining a modified second subtitle in response to modification of a second subtitle in a first subtitle, where the first subtitle is a subtitle of a first video, and the second subtitle is a part to be modified in the first subtitle; determining a first subtitle image of the modified second subtitle based on subtitle images stored in a memory, where the memory manages the subtitle images stored based on a first policy; and processing a second subtitle image of the second subtitle in the first video based on the first subtitle image to obtain a second video.

### CROSS-REFERENCE TO RELATED APPLICATION

The present application claims priority to Chinese Patent Application No. 202510344801.8 filed on Mar. 21, 2025, which is incorporated by reference in its entirety as a part of the present application.

### TECHNICAL FIELD

One or more embodiments of the present disclosure relate to a method for processing subtitle, a device, and a storage medium.

### BACKGROUND

In a multimedia editing scenario, a user may add a subtitle to a video, so that when the video is played, the user may clearly determine audio content of the video by listening to audio and watching the subtitle.

In the related art, when the user modifies a subtitle that has been added to a video, a terminal device may perform full replacement on a subtitle image in the video. For example, the video includes 100 subtitle images. When the user modifies at least one subtitle, the terminal device may re-generate 100 subtitle images based on the modified subtitle, and replace the previous 100 subtitle images with the re-generated 100 subtitle images, thereby implementing subtitle modification. However, in the above method, efficiency of subtitle modification is relatively low.

### SUMMARY

One or more embodiments of the present disclosure provide a method for processing subtitle and apparatus, a terminal device, a storage medium, and a program product for solving the technical problems in the prior art.

At least an embodiment of the present disclosure provides a method for processing subtitle, including:

determining a modified second subtitle in response to modification of the second subtitle in a first subtitle, where the first subtitle is a subtitle of a first video, and the second subtitle is a part to be modified in the first subtitle;

determining a first subtitle image for the modified second subtitle based on subtitle images stored in a memory, where the memory manages the subtitle images stored based on a first policy; and

processing a second subtitle image of the second subtitle in the first video based on the first subtitle image to obtain a second video.

At least an embodiment of the present disclosure provides an apparatus for processing subtitle, including a first determination module, a second determination module, and a processing module, where:

the first determination module is configured to determine a modified second subtitle in response to modification of the second subtitle in a first subtitle, where the first subtitle is a subtitle of a first video, and the second subtitle is a part to be modified of the first subtitle;

the second determination module is configured to determine a first subtitle image of the modified second subtitle based on subtitle images stored in a memory, where the memory manages the subtitle images stored based on a first policy; and

the processing module is configured to process a second subtitle image of the second subtitle in the first video based on the first subtitle image to obtain a second video.

At least an embodiment of the present disclosure provides a device (for example, a terminal device), including: at least one processor and at least one memory, where:

the at least one memory stores a computer-executable instruction; and

the at least one processor executes the computer-executable instruction stored in the at least one memory, so as to enable the at least one processor to execute the method for processing subtitle according to the first aspect and various possible implementations of the first aspect.

At least an embodiment of the present disclosure provides a computer-readable storage medium, where a computer-executable instruction is stored in the computer-readable storage medium, and when the computer-executable instruction is executed by a processor, the method for processing subtitle according to the first aspect and various possible implementations of the first aspect is implemented.

At least an embodiment of the present disclosure provides a computer program product, including a computer program, where the method for processing subtitle according to the first aspect and various possible implementations of the first aspect is implemented when the computer program is executed by a processor.

### BRIEF DESCRIPTION OF DRAWINGS

In order to more clearly describe the technical solutions in the embodiments of the present disclosure or in the prior art, the following briefly introduces the drawings required for describing the embodiments or the prior art. Apparently, the drawings in the following description show some embodiments of the present disclosure, and other drawings may also be obtained by a person of ordinary skill in the art according to these drawings without creative efforts.

FIG. 1 is a schematic diagram of an application scenario provided by at least an embodiment of the present disclosure;

FIG. 2 is a schematic flowchart of a method for processing subtitle provided by at least an embodiment of the present disclosure;

FIG. 3 is a schematic diagram of a first type provided by at least an embodiment of the present disclosure;

FIG. 4 is a schematic diagram of a first type provided by at least an embodiment of the present disclosure;

FIG. 5 is a schematic diagram of a first type provided by at least an embodiment of the present disclosure;

FIG. 6 is a schematic diagram of a first type provided by at least an embodiment of the present disclosure;

FIG. 7 is a schematic diagram of processing a subtitle image of a second subtitle provided by at least an embodiment of the present disclosure;

FIG. 8 is a schematic diagram of processing a subtitle image of a second subtitle provided by at least an embodiment of the present disclosure;

FIG. 9 is a schematic diagram of processing a subtitle image of a second subtitle provided by at least an embodiment of the present disclosure;

FIG. 10 is a schematic flowchart of a method for acquiring a first subtitle provided by at least an embodiment of the present disclosure;

FIG. 11 is a schematic diagram of a method for managing subtitle images provided by at least an embodiment of the present disclosure;

FIG. 12 is a schematic structural diagram of an apparatus for processing subtitle provided by at least an embodiment of the present disclosure; and

FIG. 13 is a schematic structural diagram of a terminal device provided by at least an embodiment of the present disclosure.

### DETAILED DESCRIPTION

Here, the exemplary embodiments will be described in detail, and examples thereof are shown in the drawings. In the following description, when referring to the drawings, unless otherwise specified, the same numbers in different drawings represent the same or similar elements. The implementations described in the following exemplary embodiments do not represent all implementations consistent with the present disclosure. On the contrary, they are only examples of apparatuses and methods consistent with some aspects of the present disclosure as detailed in the appended claims.

It may be understood that before the technical solutions disclosed in the embodiments of the present disclosure are used, the user shall be informed of the type, range of use, use scenarios, etc. of personal information involved in the present disclosure in an appropriate manner and obtain the authorization of the user in accordance with relevant laws and regulations.

For example, in response to receiving an active request from a user, prompt information is sent to the user to clearly prompt the user that the requested operation will require access to and use of the user’s personal information. In this way, the user may independently choose, based on the prompt information, whether to provide the personal information to software or hardware, such as a terminal device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to select whether to “agree” or “disagree” to provide the personal information to the terminal device.

It may be understood that the above process of notifying and obtaining user authorization is only illustrative and does not limit the implementations of the present disclosure, and other manners that satisfy the relevant laws and regulations may also be applied in the implementations of the present disclosure.

For ease of understanding, the following explains the concepts involved in the embodiments of the present disclosure.

Terminal device: a device with a wireless transceiver function. The terminal device may be deployed on land, including indoors or outdoors, handheld, wearable, or vehicle-mounted. The terminal device may be a mobile phone, a tablet computer, a computer with a wireless transceiver function, a virtual reality (VR) terminal device, an augmented reality (AR) terminal device, a wireless terminal in industrial control, a vehicle-mounted terminal device, a wireless terminal in self driving, a wireless terminal device in remote medical, a wireless terminal device in a smart grid, a wireless terminal device in transportation safety, a wireless terminal device in a smart city, a wireless terminal device in a smart home, a wearable terminal device, etc. The terminal device involved in the embodiments of the present disclosure may also be referred to as a terminal, a user equipment (UE), an access terminal device, a vehicle-mounted terminal, an industrial control terminal, a UE unit, a UE station, a mobile station, a mobile platform, a remote station, a remote terminal device, a mobile device, a UE terminal device, a wireless communication device, a UE agent, or a UE apparatus, etc. The terminal device may also be fixed or mobile.

The following describes an application scenario of embodiments of the present disclosure with reference to FIG. 1.

FIG. 1 is a schematic diagram of an application scenario provided by at least an embodiment of the present disclosure. Referring to FIG. 1, the application scenario includes a terminal device. An interface displayed by the terminal device includes a preview region and an editing region of a video. The preview region includes the video, the video includes a subtitle "ABCDEF", and the editing region includes a video clip corresponding to the video and a subtitle segment "ABCDEF". When a user modifies the subtitle to "ABCD", the subtitle segment in the editing region changes from "ABCDEF" to "ABCD", and the subtitle at the bottom of the video in the preview region also changes from "ABCDEF" to "ABCD". In this way, the user may modify the subtitle in the video, thereby improving the flexibility of video editing.

For example, a subtitle in a video may be added to the video in the form of an image. For example, a terminal device may convert a subtitle into an image, where the content of the image is the content of the subtitle, and the terminal device may display the image of the subtitle in the process of playing the video, thereby achieving the effect of displaying the subtitle in the video. Because the subtitle image occupies a relatively large amount of content, the terminal device may generate a subtitle image for the subtitle in full. For example, after the user edits all subtitles of the video, the terminal device may convert all the subtitles into multiple subtitle images at one time, and add the multiple subtitle images to the video. However, when the user modifies some of the subtitles, the terminal device also re-converts all the subtitles into multiple subtitle images after the user modifies all the subtitles, and performs full replacement on the original multiple subtitle images in the video based on the newly converted multiple subtitle images, thereby implementing subtitle modification.

For example, in the scenario shown in FIG. 1, if the video also includes a subtitle "12345", after the user modifies the subtitle "ABCDEF" to "ABCD", the terminal device may re-generate a subtitle image of the subtitle "ABCD" and a subtitle image of the subtitle "12345", and replace the original subtitle images in the video based on the re-generated subtitle images, thereby modifying the subtitle "ABCDEF" in the video to the subtitle "ABCD". In the above method, full replacement of subtitle images may cause unnecessary waste, and may lead to low efficiency of subtitle modification. Moreover, the user cannot preview the result of subtitle modification in real time, resulting in a poor user experience.

At least an embodiment of the present disclosure provides a method for processing subtitle. In the method, a modified second subtitle is determined in response to modification of the second subtitle in a first subtitle; a first subtitle image for the modified second subtitle is determined based on subtitle images stored in a memory; a first type associated with the modified second subtitle is acquired; and a second subtitle image of the second subtitle in a first video is processed based on the first type and the first subtitle image to obtain a second video. In the above method, because the first type may include subtitle replacement, subtitle deletion, subtitle insertion, and subtitle addition, the flexibility of subtitle modification may be improved. Moreover, because the terminal device may manage the subtitle images stored in the memory, a stuttering problem caused by a high proportion of subtitle images may be avoided. Moreover, because the terminal device may replace the modified subtitle, and does not need to perform full replacement on all subtitles, the time required for subtitle modification may be reduced, and the efficiency of subtitle modification may be improved. In this way, the user may browse the modified subtitle in real time, thereby improving the user experience.

The following describes the technical solutions of the present disclosure and how the technical solutions of the present disclosure solve the above technical problems in detail with specific embodiments. The following specific embodiments may be combined with each other, and the same or similar concepts or processes may not be described in detail in some embodiments. The embodiments of the present disclosure will be described below with reference to the drawings.

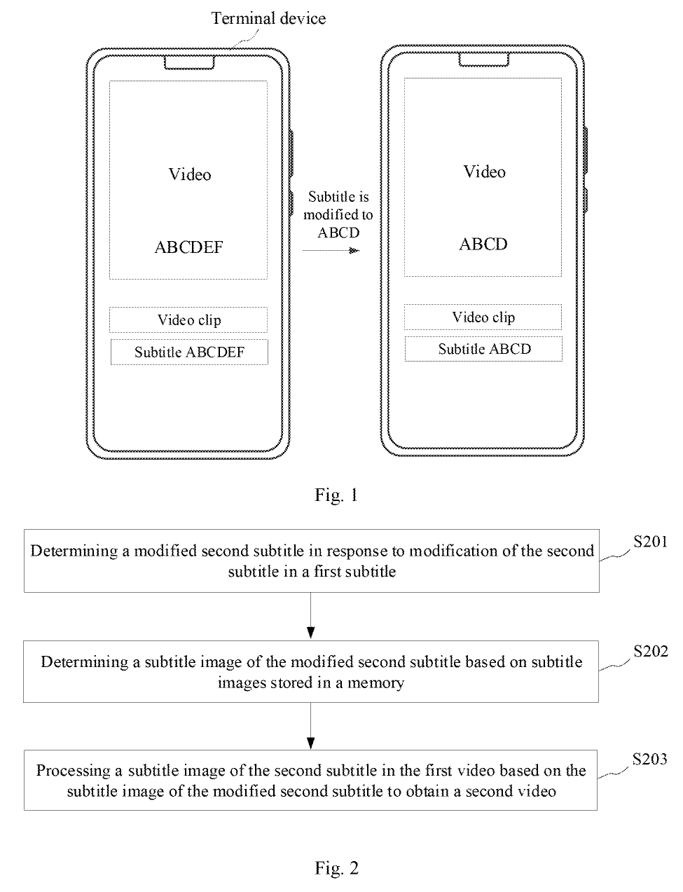

FIG. 2 is a schematic flowchart of a method for processing subtitle provided by at least an embodiment of the present disclosure. Referring to FIG. 2, the method may include the following steps.

S201: determining a modified second subtitle in response to modification of the second subtitle in a first subtitle.

An execution body of this embodiment of the present disclosure may be a terminal device, or may be an apparatus for processing subtitle disposed in the terminal device. The apparatus for processing subtitle may be implemented based on software, or may be implemented based on a combination of software and hardware, which is not limited in this embodiment of the present disclosure.

The first subtitle may be a subtitle of a first video. For example, the first video may be a video including a subtitle, and the first subtitle may be all subtitles of the first video, or may be some subtitles of the first video, which is not limited in this embodiment of the present disclosure. For example, in a process of editing the video, the user may add a subtitle to the video, and the terminal device may determine the video as the first video. For example, the user may select a video clip 1, a video clip 2, and a video clip 3 for editing, and the user may add a subtitle to the video clip 1, so that the terminal device may determine the video clip 1 as the first video, and after the video clip 1, the video clip 2, and the video clip 3 are merged, the terminal device may determine the merged video as the first video.

Exemplarily, the terminal device may display a first interface, and the first interface may include a main track and a secondary track for video or image editing. The user may add a video clip to the main track, and the terminal device may extract audio of the video clip and acquire the first subtitle based on the audio of the video clip.

In some embodiments, the second subtitle may be a part to be modified of the first subtitle. For example, the first subtitle may include 100 subtitle segments, and if the user modifies 10 of the subtitle segments, the terminal device may determine the 10 subtitle segments as the second subtitle. For example, the first subtitle includes a subtitle 1, a subtitle 2, and a subtitle 3, and if the user modifies the subtitle 1, the terminal device may determine the subtitle 1 as the second subtitle.

Exemplarily, the first subtitle is "123456", and if the user modifies "123456" to "123756", the terminal device may determine the subtitle "4" in the first subtitle as the second subtitle.

Exemplarily, the first subtitle includes a subtitle "12345" and a subtitle "ABCDE", and if the user modifies the subtitle "12345" to a subtitle "12745", the terminal device may determine the subtitle "3" as the second subtitle, or the terminal device may determine the subtitle "12345" as the second subtitle, which is not limited in this embodiment of the present disclosure.

It should be noted that the terminal device may determine the second subtitle based on the modification of the first subtitle by the user, or may determine the second subtitle based on any feasible implementation, which is not limited in this embodiment of the present disclosure.

In some embodiments, when the number of words of the first subtitle in the first video is relatively large, the terminal device may divide the first subtitle into multiple subtitle segments, and the multiple subtitle segments may be the first subtitle of the first video. For example, the first subtitle of the first video may include multiple pieces of text, and the terminal device may divide the multiple pieces of text into multiple subtitle segments based on punctuation marks between the multiple pieces of text. For example, the first subtitle includes 10 pieces of text, and the 10 pieces of text include one punctuation mark, and the terminal device may segment the 10 pieces of text at the position of the punctuation mark to obtain two text segments, where each text segment may be the content of the subtitle segment of the first subtitle.

The modified second subtitle may be a subtitle obtained after the second subtitle is modified. For example, the first subtitle includes a subtitle A and a subtitle B, and if the user modifies the subtitle A to a subtitle C, the terminal device may determine the subtitle A as the second subtitle, and determine the subtitle C as the modified second subtitle; and if the user modifies the subtitle B to a subtitle D, the terminal device may determine the subtitle B as the second subtitle, and determine the subtitle D as the modified second subtitle.

In some embodiments, the modification of the subtitle may include replacement of the subtitle, deletion of the subtitle, insertion of the subtitle, and addition of a subtitle. For example, the replacement of the subtitle may be that the terminal device replaces text in a subtitle segment with new text, the deletion of the subtitle may be that the terminal device deletes text in a subtitle segment, the insertion of the subtitle may be that the terminal device inserts new text into an original subtitle segment, and the addition of a subtitle may be that the terminal device adds a new subtitle segment after a subtitle segment.

S202: determining a subtitle image of the modified second subtitle based on subtitle images stored in a memory. For example, the subtitle image of the modified second subtitle in at least an embodiment of the present disclosure may be described as a first subtitle image, which is used for the modified second subtitle.

The memory may be used for storing subtitle images. For example, after the terminal device generates a subtitle image for the first subtitle, the subtitle image may be stored in the memory, so that when the terminal device displays the result of video editing, the subtitle image may be acquired from the memory, thereby improving the efficiency of displaying the result of video editing.

In some embodiments, the terminal device may determine the subtitle image (the first subtitle image) of the modified second subtitle based on the following feasible implementation: determining whether the subtitle images stored in the memory include the subtitle image of the modified second subtitle; when the subtitle images stored in the memory include the subtitle image of the modified second subtitle, the terminal device acquiring the subtitle image of the modified second subtitle based on the subtitle images stored in the memory; and when the subtitle images stored in the memory do not include the subtitle image of the modified second subtitle, the terminal device generating the subtitle image of the modified second subtitle based on the modified second subtitle. In this way, the terminal device may reuse the subtitle image based on the memory, thereby improving the smoothness of video preview.

In some embodiments, when the user modifies a subtitle, the user may quickly and repeatedly modify multiple subtitles (for example, the subtitle includes 10 pieces of text, and the user may continuously modify 8 pieces of text, and during the subtitle modification, the user may repeatedly perform deletion and addition operations on one piece of text), therefore, each time the terminal device determines a modified second subtitle, the terminal device may generate a subtitle image for the modified second subtitle, and store the subtitle image of the modified second subtitle in the memory. When the terminal device renders the subtitle image of the modified second subtitle, if the memory includes the subtitle image of the modified second subtitle, the terminal device may acquire the subtitle image of the modified second subtitle from the memory, and if the memory does not include the subtitle image of the modified second subtitle, the terminal device quickly generates the subtitle image of the modified second subtitle based on the modified second subtitle, so that the smoothness of subtitle display may be improved.

Exemplarily, a subtitle segment of the first video is "ABCDEFG", and if the user modifies CDEFG to 12345, the terminal device needs to generate a subtitle image of AB1, a subtitle image of AB12, a subtitle image of AB123, a subtitle image of AB1234, and a subtitle image of AB12345, where when the memory does not include the above subtitle images, the terminal device may store the above subtitle images in the memory. If after the user modifies the subtitle to AB12345, the user deletes 5 in the subtitle, the modified second subtitle is AB1234, so that the terminal device may quickly obtain the subtitle image of AB1234 from the memory, thereby improving the efficiency of obtaining the subtitle image.

In some embodiments, the memory may manage the stored subtitle images based on a first policy. In this way, when there are relatively many subtitle images in the memory, the terminal device may delete the subtitle images stored in the memory, thereby improving the utilization efficiency of the memory.

In some embodiments, the first policy may be a first-in first-out (FIFO) policy, that is, a subtitle image stored earlier in the memory is also deleted earlier. For example, the memory includes a subtitle image 1 and a subtitle image 2, and if the subtitle image 1 is stored in the memory first, and the subtitle image 2 is stored in the memory later, when there is relatively little remaining space in the memory, the terminal device may preferentially delete the subtitle image 1 from the memory.

In some embodiments, the first policy may be a least recently used (LRU) policy, that is, the terminal device preferentially deletes a subtitle image that has been least recently used from the memory. For example, the memory includes a subtitle image 1 and a subtitle image 2, and if the subtitle image 1 has been recently used, and the subtitle image 2 has not been recently used, when there is relatively little remaining space in the memory, the terminal device may preferentially delete the subtitle image 2 from the memory.

S203: processing a subtitle image of the second subtitle in the first video based on the subtitle image (for example, the first subtitle image) of the modified second subtitle to obtain a second video. For example, the subtitle image of the second subtitle in the first video in at least an embodiment of the present disclosure may be described as a second subtitle image.

In some embodiments, the second subtitle may be a subtitle to be modified in the first subtitle.

Exemplarily, a subtitle segment of the first video is 123456, and if the user modifies the subtitle 123456 to a subtitle 12345, the terminal device may determine that the modified second subtitle is 12345, and the second subtitle to be modified is 123456.

Exemplarily, a subtitle segment of the first video is 123456, and if the user modifies the subtitle 123456 to a subtitle 1234567, the terminal device may determine that the modified second subtitle is 1234567, and the second subtitle is 123456.

Exemplarily, a subtitle segment of the first video is 123456, and if the user modifies the subtitle 123456 to a subtitle 12345A, the terminal device may determine that the modified second subtitle is 12345A, and the second subtitle is 123456.

Exemplarily, a subtitle segment of the first video is 123456, and if the user adds a new subtitle ABCD after the subtitle 123456, the terminal device may determine that the modified second subtitle is ABCD, and the second subtitle is 123456.

It should be noted that the terminal device may determine the second subtitle in the first video based on any feasible implementation, which is not limited in this embodiment of the present disclosure.

In some embodiments, the second video may be a video obtained after the second subtitle in the first video is modified. For example, the subtitle in the first video is 12345, and when the user modifies the subtitle from 12345 to ABCDE, the terminal device may obtain the second video, where the content of the second video is the same as the content of the first video, and the subtitle of the second video is ABCDE.

In some embodiments, the terminal device may process the subtitle image (for example, the second subtitle image) of the second subtitle in the first video based on the following feasible implementation: acquiring a first type associated with the modified second subtitle, and processing the subtitle image of the second subtitle based on the first type and the subtitle image of the modified second subtitle. In this way, the terminal device may replace and add the subtitle image of the second subtitle based on the type of subtitle modification, thereby improving the accuracy of subtitle processing.

The first type may include at least one selected from the group consisting of: subtitle replacement, subtitle deletion, subtitle insertion, and subtitle addition.

In some embodiments, if the modification of the subtitle by the user is replacement of the subtitle, the terminal device may determine that the first type associated with the modified second subtitle is subtitle replacement; if the modification of the subtitle by the user is deletion of the subtitle, the terminal device may determine that the first type associated with the modified second subtitle is subtitle deletion; if the modification of the subtitle by the user is insertion of the subtitle, the terminal device may determine that the first type associated with the modified second subtitle is subtitle insertion; and if the modification of the subtitle by the user is adding a new subtitle, the terminal device may determine that the first type associated with the modified second subtitle is subtitle addition.

It should be noted that the subtitle insertion is to insert a new subtitle within the current subtitle segment, and the subtitle addition is to add a new subtitle segment in the video. For example, the first video includes 100 subtitle segments, and if the user inserts a new subtitle into one of the subtitle segments to obtain the second video, the second video also includes 100 subtitle segments, that is, the modification of the subtitle by the user is subtitle insertion; and if the user adds a new subtitle segment after one of the subtitle segments to obtain the second video, the second video includes 101 subtitle segments, that is, the modification of the subtitle by the user is subtitle addition.

It should be noted that when the first type is subtitle addition, the second subtitle corresponding to the added subtitle (the modified second subtitle) may be a subtitle segment before the added subtitle, or may be a subtitle segment after the added subtitle, which is not limited in this embodiment of the present disclosure.

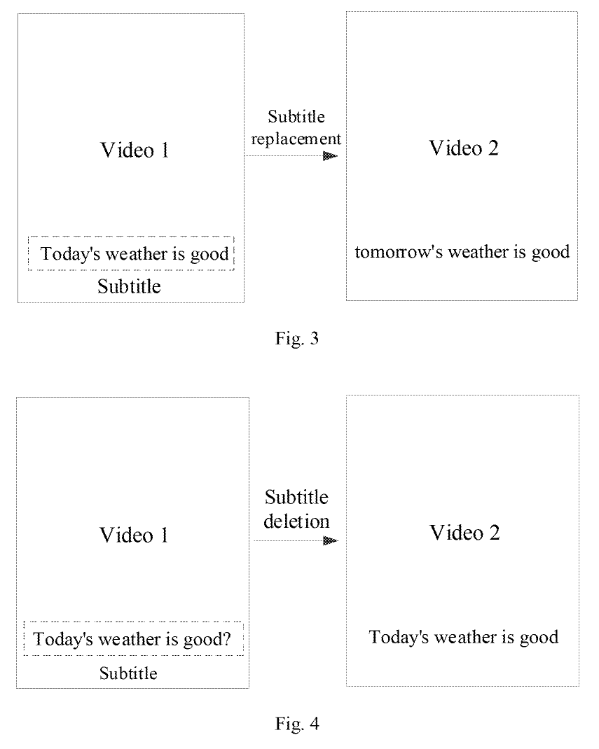

The first type will be described in detail below with reference to FIGS. 3 to 6.

FIG. 3 is a schematic diagram of a first type provided by at least an embodiment of the present disclosure. In the embodiment shown in FIG. 3, the first type is subtitle replacement. Referring to FIG. 3, it includes a video 1. A subtitle segment of the video 1 is "today's weather is good", and the user may replace "today" in the subtitle segment with "tomorrow" to obtain a video 2, where a subtitle of the video 2 is "tomorrow's weather is good", and thus the first type of the subtitle may be subtitle replacement.

FIG. 4 is a schematic diagram of a first type provided by at least an embodiment of the present disclosure. In the embodiment shown in FIG. 4, the first type is subtitle deletion. Referring to FIG. 4, it includes a video 1. A subtitle segment of the video 1 is "today's weather is good?", and the user may delete "?" in the subtitle segment to obtain a video 2, where a subtitle of the video 2 is "today's weather is good", and thus the first type of the subtitle may be subtitle deletion.

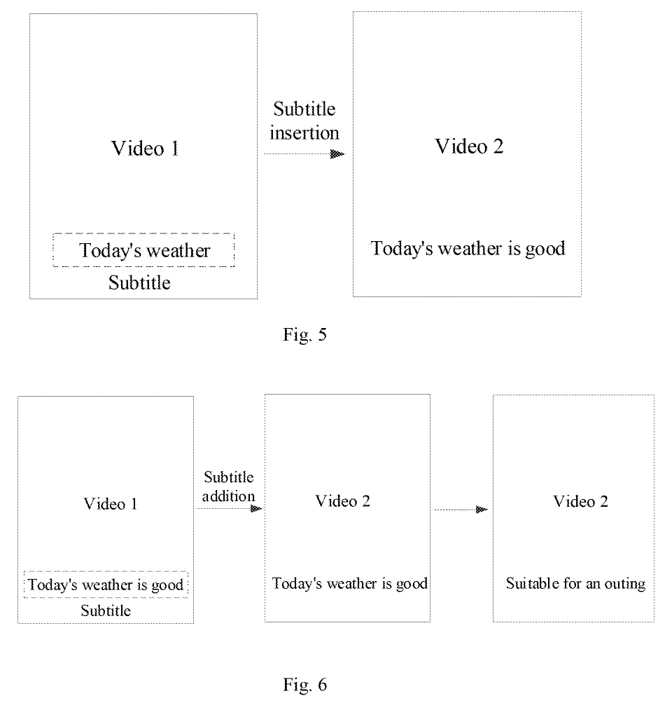

FIG. 5 is a schematic diagram of a first type provided by at least an embodiment of the present disclosure. In the embodiment shown in FIG. 5, the first type is subtitle insertion. Referring to FIG. 5, it includes a video 1. A subtitle segment of the video 1 is "today's weather", and the user may insert "is good" after "weather" into the subtitle segment to obtain a video 2, where a subtitle of the video 2 is "today's weather is good", and thus the first type of the subtitle may be subtitle insertion.

FIG. 6 is a schematic diagram of a first type provided by at least an embodiment of the present disclosure. In the embodiment shown in FIG. 6, the first type is subtitle addition. Referring to FIG. 6, it includes a video 1. A subtitle segment of the video 1 is "today's weather is good", and the user may add a new subtitle segment "suitable for an outing" after the subtitle segment to obtain a video 2, where subtitles of the video 2 include "today's weather is good" and "suitable for an outing", and thus the first type of the subtitle may be subtitle addition, where "today's weather is good" is the part to be modified (the second subtitle), and "suitable for an outing" is the modified second subtitle.

In some embodiments, the terminal device processes the subtitle image of the second subtitle based on the first type and the subtitle image of the modified second subtitle in the following three cases.

Case 1: The first type is subtitle replacement or subtitle deletion.

When the first type is subtitle replacement or subtitle deletion, the terminal device may replace the subtitle image of the second subtitle with the subtitle image of the modified second subtitle.

Exemplarily, the second subtitle appears at the 1st second to the 3rd second of the first video, and if the user replaces or deletes content in the second subtitle, the terminal device may add a subtitle image of the modified second subtitle (a subtitle obtained after the content of the second subtitle is replaced or deleted) at the 1st second to the 3rd second of the first video, and delete the subtitle image of the second subtitle to obtain the second video, so that when the second video is played to the 1st second to the 3rd second, the terminal device may display the subtitle image of the modified second subtitle.

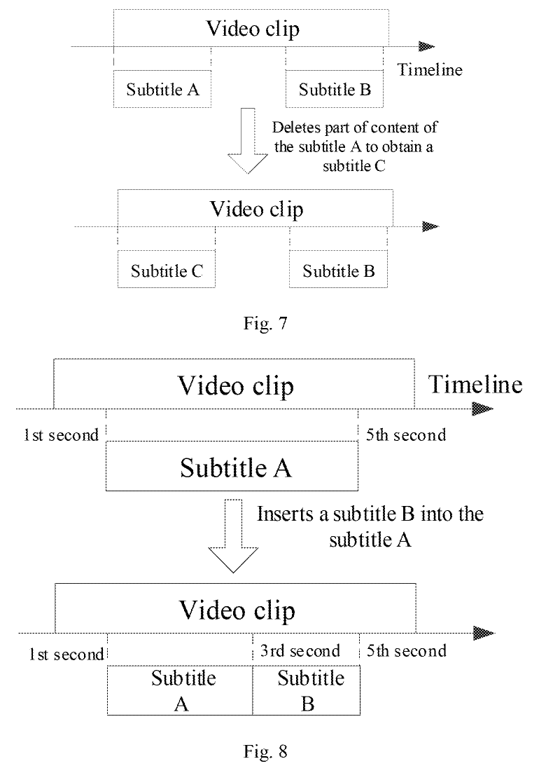

The following describes in detail the process of processing the subtitle image of the second subtitle by the terminal device with reference to FIG. 7.

FIG. 7 is a schematic diagram of processing a subtitle image of a second subtitle provided by at least an embodiment of the present disclosure. Referring to FIG. 7, the processing includes a timeline. The timeline includes a video clip, a subtitle image of a subtitle A, and a subtitle image of a subtitle B. The subtitle image of the subtitle A is at the beginning of the video clip, and the subtitle image of the subtitle B is at the end of the video clip. When the user deletes part of content of the subtitle A to obtain a subtitle C, a terminal device (not shown in FIG. 7) may replace the subtitle image of the subtitle A with a subtitle image of the subtitle C.

Case 2: The first type is subtitle insertion.

When the first type is subtitle insertion, the terminal device may insert the subtitle image of the modified second subtitle in a first period of time of the first video.

In some embodiments, the first period of time may be a period of time in which the subtitle image of the second subtitle is displayed in the first video. For example, if the second subtitle is displayed at the 1st second to the 3rd second of the first video, the terminal device may determine that the first period of time in which the second subtitle is displayed in the first video is the 1st second to the 3rd second of the first video.

Exemplarily, the second subtitle is displayed at the 1st second to the 5th second of the first video, and if the user inserts a new subtitle to the second subtitle to obtain the second video, the new subtitle may also be displayed at the 1st second to the 5th second of the second video.

The following describes in detail the process of processing the subtitle image of the second subtitle by the terminal device with reference to FIG. 8.

FIG. 8 is a schematic diagram of processing a subtitle image of a second subtitle provided by at least an embodiment of the present disclosure. Referring to FIG. 8, the processing includes a timeline. The timeline includes a video clip, a subtitle image of a subtitle A. The subtitle image of the subtitle A is at the 1st second to the 5th second of the video clip. When the user inserts a subtitle B into the subtitle A, a terminal device (not shown in FIG. 8) may determine that a period of time in which the subtitle image of the subtitle A is valid is the 1st second to the 3rd second, and determine that a period of time in which a subtitle image of the subtitle B is valid is the 3rd second to the 5th second.

It should be noted that, in the embodiment shown in FIG. 8, the terminal device may determine the period of time in which the subtitle A and the subtitle B are valid based on any feasible implementation, which is not limited in this embodiment of the present disclosure.

Case 3: The first type is subtitle addition.

When the first type is subtitle addition, the terminal device may determine a second period of time for adding the modified second subtitle, and add the subtitle image of the modified second subtitle in the second period of time.

In some embodiments, the second period of time may be a period of time in which the modified second subtitle is displayed in the second video. For example, if the terminal device determines that the modified second subtitle is displayed at the 1st second to the 3rd second of the second video, the terminal device may determine that the second period of time is the 1st second to the 3rd second of the second video.

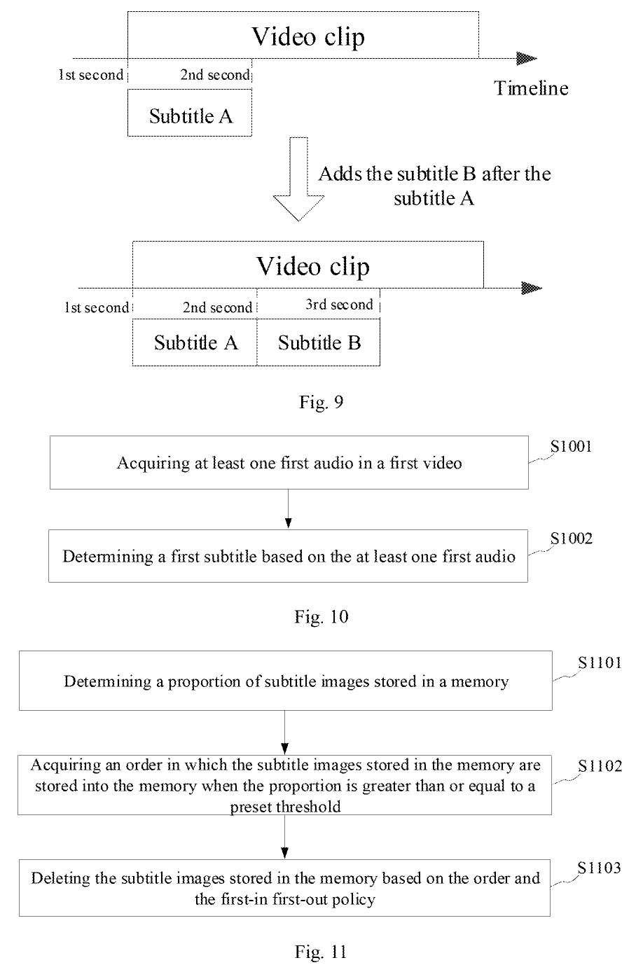

The following describes in detail the process of processing the subtitle image of the second subtitle by the terminal device with reference to FIG. 9.

FIG. 9 is a schematic diagram of processing a subtitle image of a second subtitle provided by at least an embodiment of the present disclosure. Referring to FIG. 9, the processing includes a timeline. The timeline includes a video clip, a subtitle image of a subtitle A. The subtitle image of the subtitle A is displayed at the 1st second to the 2nd second (the first period of time) of the video clip. When the user adds the subtitle B after the subtitle A, a terminal device (not shown in FIG. 9) may determine that a period of time in which a subtitle image of the subtitle B is valid is the 2nd second to the 3rd second (the second period of time).

According to the method for processing subtitle provided by the embodiment of the present disclosure, the terminal device determines the modified second subtitle in response to the modification of the second subtitle in the first subtitle; the terminal device determines whether the subtitle images stored in the memory include the subtitle image of the modified second subtitle; if yes, the terminal device may acquire the subtitle image of the modified second subtitle based on the subtitle images stored in the memory, and if not, the terminal device may generate the subtitle image of the modified second subtitle based on the modified second subtitle; the terminal device may obtain the first type associated with the modified second subtitle; when the first type is subtitle replacement or subtitle deletion, the terminal device may replace the subtitle image of the second subtitle with the subtitle image of the modified second subtitle; when the first type is subtitle insertion, the terminal device may insert the subtitle image of the modified second subtitle in the first period of time; and when the first type is subtitle addition, the terminal device may determine the second period of time for adding the modified second subtitle, and add the subtitle image of the modified second subtitle in the second period of time, so that the second video may be obtained. In the above method, the terminal device may generate the image of the modified subtitle in real time, so that the user may browse the content of the modified subtitle in real time on the preview page, thereby improving the user experience. Moreover, because the terminal device only needs to process the modified second subtitle, and does not need to process all subtitles in the first video, the complexity of subtitle modification may be reduced, and the efficiency of subtitle modification may be improved.

On the basis of the embodiment shown in FIG. 2, before the terminal device responds to the modification of the second subtitle in the first subtitle, the method for processing subtitle may further include the method for obtaining the first subtitle. The following describes in detail the method for obtaining the first subtitle by the terminal device with reference to FIG. 10.

FIG. 10 is a schematic flowchart of a method for obtaining a first subtitle provided by at least an embodiment of the present disclosure. Referring to FIG. 10, the method flowchart includes the following steps.

S1001: acquiring at least one first audio in a first video.

Optionally, the terminal device may acquire the first video based on any feasible implementation.

The at least one first audio may include at least one of the following: audio of a video clip in the first video, audio of an effect used in the first video, and audio added to the first video.

In some embodiments, when the user edits the first video, if there is audio including speech in the video clip added by the user, the audio may affect the first subtitle of the first video, therefore, when determining the first subtitle of the first video, the terminal device may acquire the audio of the video clip in the first video.

In some embodiments, when the user edits the first video, if there is audio including speech in the effect used by the user in the first video, the audio may also affect the first subtitle of the first video, therefore, when determining the first subtitle of the first video, the terminal device may acquire the audio of the effect used in the first video.

In some embodiments, when the user edits the first video, the user may add a segment of audio including speech to the first video, and the segment of audio may affect the first subtitle of the first video, therefore, when determining the first subtitle of the first video, the terminal device may acquire the audio added by the user to the first video.

In some embodiments, the terminal device may merge the video clip, the effect, and the audio added by the user (for example, merge a video track, an audio track, and a music track) to obtain the first video, and the terminal device may extract audio of the first video to obtain the first audio. In this way, the terminal device may obtain all audio, ensure that no audio information is lost, and thus improve the accuracy of the subtitle.

S1002: determining a first subtitle based on the at least one first audio.

In some embodiments, the terminal device may determine the first subtitle based on the following feasible implementation: when the number of the at least one first audio is 1, generating the first subtitle based on the at least one first audio, and when the number of the at least one first audio is greater than 1, determining a second audio with a largest volume from the at least one first audio, and generating the first subtitle based on the second audio. In this way, the terminal device may accurately generate the first subtitle, thereby improving the accuracy of the first subtitle.

Exemplarily, if the first video only includes the audio of the video clip, the terminal device may determine text corresponding to the audio of the video clip, and generate the first subtitle based on the text corresponding to the audio of the video clip. If the first video only includes the audio of the effect used in the first video, the terminal device may determine text corresponding to the audio of the effect, and generate the first subtitle based on the text corresponding to the audio of the effect. If the first video only includes the audio added by the user to the first video, the terminal device may determine text corresponding to the added audio, and generate the first subtitle based on the text corresponding to the added audio.

It should be noted that the terminal device may convert speech into text based on any feasible implementation, which is not limited in this embodiment of the present disclosure.

It should be noted that after determining the text of the first audio, the terminal device may segment the text to obtain the first subtitle based on any feasible implementation, which is not limited in this embodiment of the present disclosure.

In some embodiments, the second audio may be audio with the largest volume. For example, the first video includes the audio of the video clip, the audio of the effect used in the first video, and the audio added by the user to the first video, and if the audio of the video clip has the largest volume, the terminal device may determine that the second audio is the audio of the video clip; if the audio of the effect has the largest volume, the terminal device may determine that the second audio is the audio of the effect; and if the added audio has the largest volume, the terminal device may determine that the second audio is the added audio.

In some embodiments, when the number of the at least one first audio is greater than 1, the terminal device may determine text corresponding to the second audio, and generate the first subtitle based on the text corresponding to the second audio. In this way, when there is relatively much audio in the first video, the terminal device may also accurately determine the first subtitle, thereby improving the accuracy of the first subtitle.

At least an embodiment of the present disclosure provides a method for obtaining a subtitle of a first video. In the method, a terminal device may obtain at least one first audio in the first video; when the number of the at least one first audio is 1, the terminal device may generate a first subtitle based on the first audio, and when the number of the at least one first audio is greater than 1, the terminal device may determine a second audio with the largest volume from the at least one first audio, and generate the first subtitle based on the second audio. In the above method, because the at least one first audio may include at least one of the following: audio of a video clip in the first video, audio of an effect used in the first video, and audio added by a user to the first video, the terminal device may ensure the integrity of obtained audio, and moreover, when there is a relatively large amount of audio, the terminal device may also generate the first subtitle based on the audio with the largest volume, so that the accuracy of the first subtitle may be improved.

On the basis of any of the above embodiments, the method for processing subtitle further includes a method for managing subtitle images in a memory, where a first policy for managing the memory by the terminal device is a first in first out policy. The following describes the method for managing subtitle images in detail with reference to FIG. 11.

FIG. 11 is a schematic diagram of a method for managing subtitle images provided by at least an embodiment of the present disclosure. The first policy is the first-in first-out policy. Referring to FIG. 11, the method flowchart includes the following steps.

S1101: determining a proportion of subtitle images stored in a memory.

In some embodiments, the proportion of the subtitle images may be a ratio of a storage space occupied by the subtitle images already stored in the memory to the storage space of the memory. For example, if the storage space of the memory is 100M, and 50M subtitle images have been stored in the memory, the terminal device determines that the proportion of the subtitle images in the memory is 50%.

In some embodiments, the proportion of the subtitle images may also be the storage space occupied by the subtitle images already stored in the memory. For example, if 50M subtitle images have been stored in the memory, the terminal device may determine that the proportion of the subtitle images in the memory is 50M.

It should be noted that the terminal device may determine the proportion of the subtitle images in the memory based on any feasible implementation, which is not limited in this embodiment of the present disclosure.

S1102: acquiring an order in which the subtitle images stored in the memory are stored into the memory when the proportion is greater than or equal to a preset threshold.

In some embodiments, when the proportion is greater than or equal to the preset threshold, it represents that there is relatively little remaining storage space in the memory, therefore, the terminal device may manage the subtitle images stored in the memory based on the first policy.

In some embodiments, the terminal device may determine the order in which the subtitle images are stored into the memory based on the timestamps when the subtitle images are stored into the memory, or may determine the order in which the subtitle images are stored into the memory based on any feasible implementation, which is not limited in this embodiment of the present disclosure.

S1103: deleting the subtitle images stored in the memory based on the order and the first-in first-out policy.

In some embodiments, when the proportion of the subtitle images is the ratio of the storage space occupied by the subtitle images already stored in the memory to the storage space of the memory, the terminal device may determine that the preset threshold is any one selected from the group consisting of 10%, 20%, 30%, 40%, 50%, 60%, 70%, 80%, and 10%-90%, which is not limited in this embodiment of the present disclosure.

In some embodiments, when the proportion of the subtitle images is the storage space occupied by the subtitle images already stored in the memory, the terminal device may determine that the preset threshold is any value such as 1M, 10M, or 100M, which is not limited in this embodiment of the present disclosure.

In some embodiments, when the proportion is greater than or equal to the preset threshold, it indicates that there is relatively little remaining storage space in the memory, and preview stuttering may occur, therefore, the terminal device may delete the subtitle images already stored in the memory, where the terminal device may delete the already stored subtitle images based on the FIFO policy until the proportion of the subtitle images in the memory is less than the preset threshold, and then the terminal device stops deleting the subtitle images in the memory.

Exemplarily, when the proportion is greater than or equal to the preset threshold, the memory may include 100 subtitle images, and the terminal device may acquire the order in which the 100 subtitle images are stored into the memory, and sequentially delete the subtitle images that are stored into the memory first until the proportion is less than the preset threshold.

Exemplarily, the memory includes a subtitle image 1, a subtitle image 2, a subtitle image 3, and a subtitle image 4, and the order in which the subtitle image 1, the subtitle image 2, the subtitle image 3, and the subtitle image 4 are stored into the memory is: subtitle image 1→subtitle image 3→subtitle image 2→subtitle image 4. When the proportion is greater than or equal to the preset threshold, the terminal device may delete the subtitle image 1. If the proportion of the subtitle image 2, the subtitle image 3, and the subtitle image 4 in the memory is also greater than the preset threshold, the terminal device may delete the subtitle image 3. If the proportion of the subtitle image 2 and the subtitle image 4 in the memory is less than the preset threshold, the terminal device may stop deleting the subtitle images in the memory, and the memory includes the subtitle image 2 and the subtitle image 4.

It should be noted that when the first policy is the LRU policy, reference may be made to the method for deleting the subtitle images in the memory by the terminal device when the first policy is the FIFO policy for the method for deleting the subtitle images in the memory by the terminal device.

At least an embodiment of the present disclosure provides a method for managing subtitle images. In the method, a terminal device determines a proportion of subtitle images in a memory; when the proportion is greater than or equal to a preset threshold, the terminal device may acquire usage time information of the subtitle images stored in the memory, and delete the subtitle images stored in the memory based on the usage time information and a least recently used policy until the proportion is less than the preset threshold. In the above method, the terminal device may manage the memory, thereby avoiding a situation in which the subtitle images occupy a relatively large proportion in the memory, resulting in stuttering, and enabling the terminal device to generate an image of a modified subtitle in real time, so that a user may browse the content of the modified subtitle in real time on a preview page, thereby improving the user experience.

In some embodiments, the usage time information of the subtitle image stored in the memory refers to the timestamp of the subtitle image being used most recently (for example, the time when the subtitle image was last called or used). For example, if a subtitle image has never been used, the time when this subtitle image is stored in the memory may be used as the usage time information.

Exemplarily, the memory includes a subtitle image 1, a subtitle image 2, a subtitle image 3, and a subtitle image 4, where the last used time of the subtitle image 1 is T01, the last used time of the subtitle image 2 is T02, the last used time of the subtitle image 3 is T03, and the last used time of the subtitle image 4 is T04. If arranged in order from earliest to most recent, the time information follows the sequence: T01→T03→T02→T04. When the proportion is greater than or equal to the preset threshold, the terminal device may delete the subtitle image 1. If the proportion of the subtitle image 2, the subtitle image 3, and the subtitle image 4 in the memory is also greater than the preset threshold, the terminal device may delete the subtitle image 3. If the proportion of the subtitle image 2 and the subtitle image 4 in the memory is less than the preset threshold, the terminal device may stop deleting the subtitle images in the memory, and the memory includes the subtitle image 2 and the subtitle image 4.

In some embodiments, the present disclosure may not only delete subtitle images stored in the memory based on the usage time information of the subtitle images and the least recently used policy, but also based on the number of times the subtitle images are used within a predefined time period and the least recently used policy (For example, the electronic device may preferentially delete, from the memory, subtitle images that are used less frequently within the predefined time period). The present disclosure is not limited thereto.

At least an embodiment of the present disclosure provides a method for managing subtitle images. In the method, a terminal device determines a proportion of subtitle images in a memory; when the proportion is greater than or equal to a preset threshold, the terminal device may acquire an order in which the subtitle images stored in the memory are stored into the memory, and delete the subtitle images stored in the memory based on the order and a first-in first-out policy until the proportion is less than the preset threshold. In the above method, the terminal device may manage the memory, thereby avoiding a situation in which the subtitle images occupy a relatively large proportion in the memory, resulting in stuttering, and enabling the terminal device to generate an image of a modified subtitle in real time, so that a user may browse the content of the modified subtitle in real time on a preview page, thereby improving the user experience.

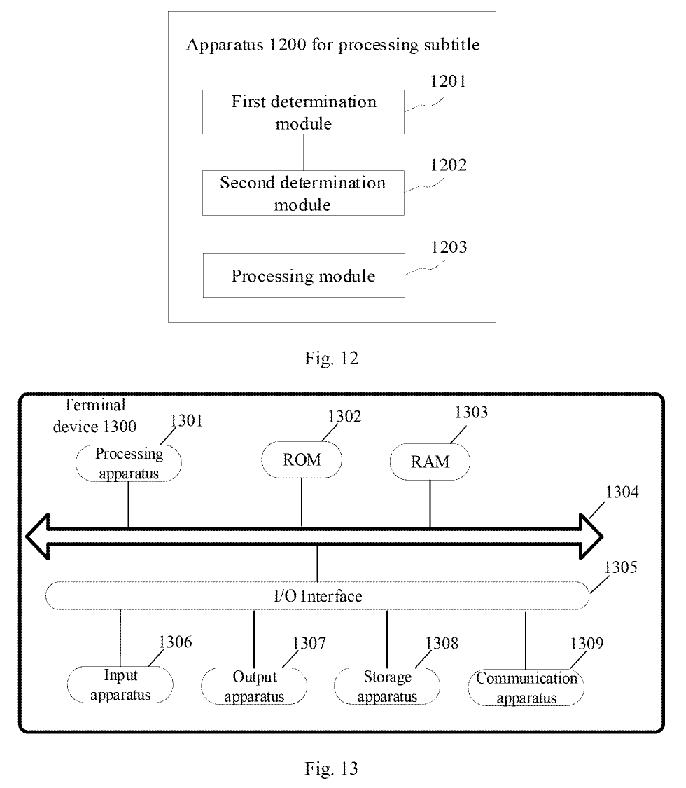

FIG. 12 is a schematic diagram of a structure of an apparatus for processing subtitle provided by at least an embodiment of the present disclosure. Referring to FIG. 12, the apparatus 1200 for processing subtitle includes a first determination module 1201, a second determination module 1202, and a processing module 1203, where:

the first determination module 1201 is configured to determine a modified second subtitle in response to modification of the second subtitle in a first subtitle, where the first subtitle is a subtitle of a first video, and the second subtitle is a part to be modified in the first subtitle;

the second determination module 1202 is configured to determine a subtitle image of the modified second subtitle based on subtitle images stored in a memory, where the memory manages the subtitle images stored based on a first policy; for example, the subtitle image of the modified second subtitle in at least an embodiment of the present disclosure may be described as a first subtitle image, which is used for the modified second subtitle; and

the processing module 1203 is configured to process a subtitle image of the second subtitle in the first video based on the subtitle image of the modified second subtitle to obtain a second video. For example, the subtitle image of the second subtitle in the first video in at least an embodiment of the present disclosure may be described as a second subtitle image.

In this way, when the second subtitle in the first subtitle is modified, the apparatus for processing subtitle only needs to process the modified second subtitle, and does not need to process all first subtitles, so that the complexity of subtitle modification may be reduced, and the efficiency of subtitle modification may be improved. Moreover, because the apparatus for processing subtitle may manage the subtitle images stored in the memory, a situation of stuttering caused by a large proportion of subtitle images may be avoided, and the apparatus for processing subtitle may generate the subtitle image of the modified second subtitle in real time, so that the user may browse the modified second subtitle in real time, thereby improving the user experience.

According to one or more embodiments of the present disclosure, the processing module 1203 is further configured to:

acquire a first type associated with the modified second subtitle, where the first type includes at least one selected from the group consisting of: subtitle replacement, subtitle deletion, subtitle insertion, and subtitle addition; and

process the subtitle image of the second subtitle based on the first type and the subtitle image of the modified second subtitle.

In this way, the apparatus for processing subtitle may replace and add the subtitle image of the second subtitle based on the type of subtitle modification, thereby improving the accuracy of subtitle processing.

According to one or more embodiments of the present disclosure, the processing module 1203 is further configured to:

when the first type is the subtitle replacement or the subtitle deletion, replace the subtitle image of the second subtitle with the subtitle image of the modified second subtitle;

when the first type is the subtitle insertion, insert the subtitle image of the modified second subtitle in a first period of time of the first video, where the first period of time is a period of time in which the subtitle image of the second subtitle is displayed in the first video; and

when the first type is the subtitle addition, determine a second period of time for adding the modified second subtitle, and add the subtitle image of the modified second subtitle in the second period of time.

In this way, when the types of subtitle modification are different, the apparatus for processing subtitle may process the subtitle image of the second subtitle based on different methods, thereby improving the flexibility of subtitle processing.

According to one or more embodiments of the present disclosure, the second determination module 1202 is further configured to:

determine whether the subtitle images stored in the memory include the subtitle image of the modified second subtitle;

when the subtitle images stored in the memory include the subtitle image of the modified second subtitle, acquire the subtitle image of the modified second subtitle based on the subtitle images stored in the memory; and

when the subtitle images stored in the memory do not include the subtitle image of the modified second subtitle, generate the subtitle image of the modified second subtitle based on the modified second subtitle.

In this way, the apparatus for processing subtitle may reuse the subtitle image based on the memory, thereby improving the smoothness of video preview.

According to one or more embodiments of the present disclosure, the processing module 1203 is further configured to:

acquire at least one first audio in the first video, where the at least one first audio includes at least one selected from the group consisting of: audio of a video clip in the first video, audio of an effect used in the first video, and audio added to the first video; and

determine the first subtitle based on the at least one first audio.

In this way, the apparatus for processing subtitle may obtain all audio, ensure that no audio information is lost, and thus improve the accuracy of the subtitle.

According to one or more embodiments of the present disclosure, the processing module 1203 is further configured to:

when the number of the at least one first audio is 1, generate the first subtitle based on the at least one first audio; and

when the number of the at least one first audio is greater than 1, determine a second audio with a largest volume from the at least one first audio, and generate the first subtitle based on the second audio.

In this way, the apparatus for processing subtitle may accurately generate the first subtitle, thereby improving the accuracy of the first subtitle.

According to one or more embodiments of the present disclosure, the processing module 1203 is further configured to:

determine a proportion of the subtitle images stored in the memory; and

acquire an order in which the subtitle images stored in the memory are stored into the memory when the proportion is greater than or equal to a preset threshold, and delete the subtitle images stored in the memory based on the order and a first-in first-out policy.

In this way, the apparatus for processing subtitle may manage the memory, thereby avoiding a situation in which the subtitle images occupy a relatively large proportion in the memory, resulting in stuttering, and enabling the terminal device to generate an image of a modified subtitle in real time, so that the user may browse the content of the modified subtitle in real time on the preview page, thereby improving the user experience.

FIG. 13 is a schematic diagram of a structure of a terminal device provided by at least an embodiment of the present disclosure. Referring to FIG. 13, it is a schematic diagram of a structure of a terminal device 1300 suitable for implementing the embodiments of the present disclosure. The terminal device may include, but is not limited to, mobile terminals such as a mobile phone, a notebook computer, a digital broadcast receiver, a personal digital assistant (abbreviated as PDA), a tablet computer, a portable media player (abbreviated as PMP), and a vehicle-mounted terminal (such as a vehicle navigation terminal), and fixed terminals such as a digital TV and a desktop computer. The terminal device shown in FIG. 13 is only an example, and should not impose any limitation on the functions and the range of use of the embodiments of the present disclosure.

As shown in FIG. 13, the terminal device 1300 may include a processing apparatus (e.g., a central processing unit, a graphics processor, etc.) 1301 that may perform various appropriate actions and processes according to a program stored in a read-only memory (abbreviated as ROM) 1302 or a program loaded from a storage apparatus 1308 into a random access memory (abbreviated as RAM) 1303. In the RAM 1303, various programs and data necessary for the operation of the terminal device 1300 are also stored. The processing apparatus 1301, the ROM 1302, and the RAM 1303 are connected to each other through a bus 1304. An input/output (I/O) interface 1305 is also connected to the bus 1304.

Typically, the following apparatuses may be connected to the I/O interface 1305: an input apparatus 1306 including, for example, a touch screen, a touchpad, a keyboard, a mouse, a camera, a microphone, an accelerometer, and a gyroscope; an output apparatus 1307 including, for example, a liquid crystal display (Liquid Crystal Display, LCD for short), a speaker, and a vibrator; a storage apparatus 1308 including, for example, a magnetic tape and a hard disk; and a communication apparatus 1309. The communication apparatus 1309 may allow the terminal device 1300 to perform wireless or wired communication with other devices to exchange data. Although FIG. 13 shows the terminal device 1300 having various apparatuses, it should be understood that it is not required to implement or have all the apparatuses shown. More or fewer apparatuses may be implemented or provided alternatively.

In particular, according to the embodiments of the present disclosure, the process described above with reference to the flowchart may be implemented as a computer software program. For example, at least an embodiment of the present disclosure includes a computer program product, which includes a computer program carried in a computer-readable medium, where the computer program includes program codes for performing the method shown in the flowchart. In such an embodiment, the computer program may be downloaded and installed from a network through the communication apparatus 1309, or installed from the storage apparatus 1308, or installed from the ROM 1302. When the computer program is executed by the processing apparatus 1301, the functions defined in the method of the embodiment of the present disclosure are executed.

It should be noted that the computer-readable medium in the present disclosure may be a computer-readable signal medium, a computer-readable storage medium, or any combination of the two. The computer-readable storage medium may be, for example, but is not limited to, an electrical, magnetic, optical, electromagnetic, infrared, or semiconductor system, apparatus or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, which may be used by or in combination with an instruction execution system, apparatus, or device. In the present disclosure, the computer-readable signal medium may include a data signal propagated on a baseband or as a part of a carrier, and computer-readable program codes are carried in the data signal. The data signal propagated in this way may be in multiple forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus, or device. The program codes contained in the computer-readable medium may be transmitted in any suitable medium, including but not limited to: a wire, an optical cable, a radio frequency (RF), etc., or any suitable combination of the above.

The computer-readable medium may be contained in the terminal device, or may exist alone without being assembled into the terminal device.

The computer-readable medium carries one or more programs, and when the one or more programs are executed by the terminal device, the terminal device is caused to execute the method shown in the above embodiments.

At least an embodiment of the present disclosure provides a computer-readable storage medium, where a computer-executable instruction is stored in the computer-readable storage medium, and when the computer-executable instruction is executed by a processor, the method according to various possible implementations of the above embodiments is implemented.

At least an embodiment of the present disclosure provides a computer program product, including a computer program, where the method according to various possible implementations of the above embodiments is implemented when the computer program is executed by a processor.

According to one or more embodiments of the present disclosure, the embodiments of the present disclosure provide a terminal device, a computer-readable storage medium, and a computer program product, and when a second subtitle in a first subtitle is modified, the terminal device only needs to process the modified second subtitle, and does not need to process all first subtitles, so that the complexity of subtitle modification may be reduced, and the efficiency of subtitle modification may be improved. Moreover, because the terminal device may manage subtitle images stored in a memory, a situation of stuttering caused by a large proportion of subtitle images may be avoided, and the terminal device may generate a subtitle image of the modified second subtitle in real time, so that the user may browse the modified second subtitle in real time, thereby improving the user experience.

The computer program codes for performing the operations of the present disclosure may be written in one or more programming languages or a combination thereof, where the programming languages include object-oriented programming languages such as Java, Smalltalk, and C++, and may also include conventional procedural programming languages such as "C" language or similar programming languages. The program codes may be executed entirely on a computer of a user, partly on a computer of a user, as a stand-alone software package, partly on a computer of a user and partly on a remote computer, or entirely on a remote computer or server. In the case of involving the remote computer, the remote computer may be connected to the computer of the user through any kind of network, including a local area network (abbreviated as LAN) or a wide area network (abbreviated as WAN), or may be connected to an external computer (for example, connected through the Internet using an Internet service provider).

The flowcharts and block diagrams in the drawings illustrate the architecture, functionality, and operation of possible implementations of systems, methods and computer program products according to various embodiments of the present disclosure. In this regard, each block in the flowchart or block diagrams may represent a module, program segment, or portion of code, which includes one or more executable instructions for implementing the specified logical function(s). It should also be noted that, in some alternative implementations, the functions noted in the block may occur in an order different from that noted in the drawings. For example, two blocks shown in succession may, in fact, be executed substantially concurrently, or the blocks may sometimes be executed in a reverse order, depending upon the functionality involved. It will also be noted that each block of the block diagrams and/or flowchart, and combinations of blocks in the block diagrams and/or flowchart, may be implemented by special purpose hardware-based systems that perform the specified functions or operations, or combinations of special purpose hardware and computer instructions.

The units or modules involved in the embodiments of the present disclosure may be implemented by software or hardware. The name of a unit or a module does not constitute a limitation on the unit itself under certain circumstances, and for example, the first determination module may also be described as a "module for determining a modified second subtitle".

The functions described above herein may be performed, at least in part, by one or more hardware logic components. For example, without limitation, exemplary types of hardware logic components that may be used include: field programmable gate array (FPGA), application specific integrated circuit (ASIC), application specific standard product (ASSP), system on chip (SOC), complex programmable logical device (CPLD), etc.

In the context of the present disclosure, a machine-readable medium may be a tangible medium that may contain or store programs for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

It should be noted that the modifiers of "one" and "multiple" mentioned in the present disclosure are illustrative and not restrictive, and those skilled in the art should understand that they should be interpreted as "one or more" unless clearly indicated in the context otherwise.

The names of messages or information exchanged between multiple apparatuses in the implementations of the present disclosure are used for illustrative purposes only, and are not used to limit the scope of these messages or information.

It may be understood that the data involved in the technical solutions (including but not limited to the data itself, acquisition or use of the data) should comply with requirements of corresponding laws, regulations, and related provisions. The data may include information, parameters, messages, etc., such as stream switching indication information.

According to the method for processing subtitle, the device, the storage medium, and the program product provided by the embodiments of the present disclosure, a modified second subtitle is determined in response to modification of a second subtitle in a first subtitle, where the first subtitle is a subtitle of the first video, and the second subtitle is a part to be modified in the first subtitle; the terminal device may determine a subtitle image of the modified second subtitle based on subtitle images stored in the memory, where the memory may manage the stored subtitle images based on a first policy; and the terminal device may process a subtitle image of the second subtitle in the first video based on the subtitle image of the modified second subtitle to obtain a second video. In the above method, when the second subtitle in the first subtitle is modified, the terminal device only needs to process the modified second subtitle, and does not need to process all first subtitles, so that the complexity of subtitle modification may be reduced, and the efficiency of subtitle modification may be improved. Moreover, because the terminal device may manage the subtitle images stored in the memory, a situation of stuttering caused by a large proportion of subtitle images may be avoided, and the terminal device may generate the subtitle image of the modified second subtitle in real time, so that the user may browse the modified second subtitle in real time, thereby improving the user experience.

According to one or more embodiments of the present application, Example 1 provides a method for processing subtitle, and this method includes:

determining a modified second subtitle in response to modification of a second subtitle in a first subtitle, wherein the first subtitle is a subtitle of a first video, and the second subtitle is a part to be modified in the first subtitle;

determining a first subtitle image for the modified second subtitle based on subtitle images stored in a memory, wherein the memory manages the subtitle images stored based on a first policy; and

processing a second subtitle image of the second subtitle in the first video based on the first subtitle image to obtain a second video.

According to one or more embodiments of the present disclosure, in Example 2 according to the method of Example 1, the processing a second subtitle image of the second subtitle in the first video based on the first subtitle image includes:

acquiring a first type associated with the modified second subtitle, wherein the first type includes at least one selected from the group consisting of: subtitle replacement, subtitle deletion, subtitle insertion, and subtitle addition; and

processing the second subtitle image based on the first type and the first subtitle image.

According to one or more embodiments of the present disclosure, in Example 3 according to the method of Example 2, the processing the second subtitle image based on the first type and the first subtitle image includes:

replacing the second subtitle image with the first subtitle image when the first type is the subtitle replacement or the subtitle deletion;

inserting the first subtitle image in a first period of time of the first video when the first type is the subtitle insertion, wherein the first period of time is a period of time in which the second subtitle image is displayed in the first video; and

determining a second period of time for adding the modified second subtitle, and adding the first subtitle image in the second period of time when the first type is the subtitle addition.

According to one or more embodiments of the present disclosure, in Example 4 according to the method of Example 1, the determining a first subtitle image for the modified second subtitle based on subtitle images stored in a memory includes:

determining whether the subtitle images stored in the memory include the first subtitle image;

acquiring the first subtitle image based on the subtitle images stored in the memory when the subtitle images stored in the memory include the first subtitle image; and

generating the first subtitle image based on the modified second subtitle when the subtitle images stored in the memory do not include the first subtitle image.

According to one or more embodiments of the present disclosure, in Example 5 according to the method of Example 1, before the determining a modified second subtitle in response to modification of a second subtitle in a first subtitle, the method further includes:

acquiring at least one first audio in the first video, wherein the at least one first audio includes at least one selected from the group consisting of: audio of a video clip in the first video, audio of an effect used in the first video, and audio added to the first video; and

determining the first subtitle based on the at least one first audio.

According to one or more embodiments of the present disclosure, in Example 6 according to the method of Example 5, the determining the first subtitle based on the at least one first audio includes:

generating the first subtitle based on the at least one first audio when the number of the at least one first audio is 1; and

determining a second audio with a largest volume from the at least one first audio, and generating the first subtitle based on the second audio when the number of the at least one first audio is greater than 1.

According to one or more embodiments of the present disclosure, in Example 7 according to the method of Example 1, the first policy is a first-in first-out policy, and the method further includes:

determining a proportion of the subtitle images stored in the memory; and

acquiring an order in which the subtitle images stored in the memory are stored into the memory when the proportion is greater than or equal to a preset threshold, and deleting the subtitle images stored in the memory based on the order and the first-in first-out policy.

According to one or more embodiments of the present disclosure, in Example 8 according to the method of Example 1, the first policy is a least recently used policy, and the method further includes:

determining a proportion of the subtitle images stored in the memory; and

acquiring usage time information of the subtitle images stored in the memory when the proportion is greater than or equal to a preset threshold, and deleting the subtitle images stored in the memory based on the usage time information and the least recently used policy.

According to one or more embodiments of the present disclosure, Example 9 provides a device, and the device includes: at least one processor and at least one memory, wherein

the at least one memory stores a computer-executable instruction; and

the at least one processor executes the computer-executable instruction stored in the at least one memory, so as to enable the at least one processor to execute the method for processing subtitle of any one of Examples 1-8.

According to one or more embodiments of the present disclosure, Example 10 provides a non-transitory computer-readable storage medium, wherein a computer-executable instruction is stored in the computer-readable storage medium, and when the computer-executable instruction is executed by a processor, the method for processing subtitle of any one of Examples 1-8 is implemented

The above description is only preferred embodiments of the present disclosure and an explanation of the applied technical principles. Those skilled in the art should understand that the scope of disclosure involved in the present disclosure is not limited to the technical solutions formed by the specific combination of the above technical features, and should also cover other technical solutions formed by any combination of the above technical features or their equivalent features without departing from the above disclosed concept. For example, the above features and the technical features provided in the present disclosure (but not limited to) with similar functions may be replaced each other to form a technical solution.

In addition, although the various operations are depicted in a particular order, this should not be understood as requiring the operations to be performed in the particular order shown or in a sequential order. Under certain circumstances, multitasking and parallel processing may be advantageous. Similarly, although the above discussion contains a number of specific implementation details, these should not be interpreted as limiting the scope of the present disclosure. Certain features described in the context of separate embodiments may also be implemented in a single embodiment in combination. Conversely, various features described in the context of a single embodiment may also be implemented in multiple embodiments individually or in any suitable sub-combination. Although the subject matter has been described in terms specific to the structural features and/or logical actions of the method, it should be understood that the subject matter defined in the appended claims is not necessarily limited to the specific features or actions described above. Conversely, the specific features and actions described above are only exemplary forms of implementing the claims.

1. A method for processing subtitle, comprising:
determining a modified second subtitle in response to modification of a second subtitle in a first subtitle, wherein the first subtitle is a subtitle of a first video, and the second subtitle is a part to be modified in the first subtitle;
determining a first subtitle image for the modified second subtitle based on subtitle images stored in a memory, wherein the memory manages the subtitle images stored based on a first policy; and
processing a second subtitle image of the second subtitle in the first video based on the first subtitle image to obtain a second video.

2. The method of claim 1, wherein the processing a second subtitle image of the second subtitle in the first video based on the first subtitle image comprises:
acquiring a first type associated with the modified second subtitle, wherein the first type comprises at least one selected from the group consisting of: subtitle replacement, subtitle deletion, subtitle insertion, and subtitle addition; and
processing the second subtitle image based on the first type and the first subtitle image.

3. The method of claim 2, wherein the processing the second subtitle image based on the first type and the first subtitle image comprises:
replacing the second subtitle image with the first subtitle image when the first type is the subtitle replacement or the subtitle deletion;
inserting the first subtitle image in a first period of time of the first video when the first type is the subtitle insertion, wherein the first period of time is a period of time in which the second subtitle image is displayed in the first video; and
determining a second period of time for adding the modified second subtitle, and adding the first subtitle image in the second period of time when the first type is the subtitle addition.

4. The method of claim 1, wherein the determining a first subtitle image for the modified second subtitle based on subtitle images stored in a memory comprises:
determining whether the subtitle images stored in the memory comprise the first subtitle image;
acquiring the first subtitle image based on the subtitle images stored in the memory when the subtitle images stored in the memory comprise the first subtitle image; and
generating the first subtitle image based on the modified second subtitle when the subtitle images stored in the memory do not comprise the first subtitle image.

5. The method of claim 1, wherein before the determining a modified second subtitle in response to modification of a second subtitle in a first subtitle, the method further comprises:
acquiring at least one first audio in the first video, wherein the at least one first audio comprises at least one selected from the group consisting of: audio of a video clip in the first video, audio of an effect used in the first video, and audio added to the first video; and
determining the first subtitle based on the at least one first audio.

6. The method of claim 5, wherein the determining the first subtitle based on the at least one first audio comprises:
generating the first subtitle based on the at least one first audio when the number of the at least one first audio is 1; and
determining a second audio with a largest volume from the at least one first audio, and generating the first subtitle based on the second audio when the number of the at least one first audio is greater than 1.

7. The method of claim 1, wherein the first policy is a first-in first-out policy, and the method further comprises:
determining a proportion of the subtitle images stored in the memory; and
acquiring an order in which the subtitle images stored in the memory are stored into the memory when the proportion is greater than or equal to a preset threshold, and deleting the subtitle images stored in the memory based on the order and the first-in first-out policy.

8. The method of claim 1, wherein the first policy is a least recently used policy, and the method further comprises:
determining a proportion of the subtitle images stored in the memory; and
acquiring usage time information of the subtitle images stored in the memory when the proportion is greater than or equal to a preset threshold, and deleting the subtitle images stored in the memory based on the usage time information and the least recently used policy.

9. The method of claim 2, wherein the determining a first subtitle image for the modified second subtitle based on subtitle images stored in a memory comprises:
determining whether the subtitle images stored in the memory comprise the first subtitle image;
acquiring the first subtitle image based on the subtitle images stored in the memory when the subtitle images stored in the memory comprise the first subtitle image; and
generating the first subtitle image based on the modified second subtitle when the subtitle images stored in the memory do not comprise the first subtitle image.

10. The method of claim 3, wherein the determining a first subtitle image for the modified second subtitle based on subtitle images stored in a memory comprises:
determining whether the subtitle images stored in the memory comprise the first subtitle image;
acquiring the first subtitle image based on the subtitle images stored in the memory when the subtitle images stored in the memory comprise the first subtitle image; and
generating the first subtitle image based on the modified second subtitle when the subtitle images stored in the memory do not comprise the first subtitle image.

11. A device, comprising: at least one processor and at least one memory, wherein
the at least one memory stores a computer-executable instruction; and
the at least one processor executes the computer-executable instruction stored in the at least one memory, so as to enable the at least one processor to execute a method for processing subtitle, which comprises:
determining a modified second subtitle in response to modification of a second subtitle in a first subtitle, wherein the first subtitle is a subtitle of a first video, and the second subtitle is a part to be modified in the first subtitle;
determining a first subtitle image for the modified second subtitle based on subtitle images stored in a memory, wherein the memory manages the subtitle images stored based on a first policy; and
processing a second subtitle image of the second subtitle in the first video based on the first subtitle image to obtain a second video.

12. The device of claim 11, wherein the processing a second subtitle image of the second subtitle in the first video based on the first subtitle image comprises:
acquiring a first type associated with the modified second subtitle, wherein the first type comprises at least one selected from the group consisting of: subtitle replacement, subtitle deletion, subtitle insertion, and subtitle addition; and
processing the second subtitle image based on the first type and the first subtitle image.

13. The device of claim 2, wherein the processing the second subtitle image based on the first type and the first subtitle image comprises:
replacing the second subtitle image with the first subtitle image when the first type is the subtitle replacement or the subtitle deletion;
inserting the first subtitle image in a first period of time of the first video when the first type is the subtitle insertion, wherein the first period of time is a period of time in which the second subtitle image is displayed in the first video; and
determining a second period of time for adding the modified second subtitle, and adding the first subtitle image in the second period of time when the first type is the subtitle addition.

14. The device of claim 11, wherein the determining a first subtitle image for the modified second subtitle based on subtitle images stored in a memory comprises:
determining whether the subtitle images stored in the memory comprise the first subtitle image;
acquiring the first subtitle image based on the subtitle images stored in the memory when the subtitle images stored in the memory comprise the first subtitle image; and
generating the first subtitle image based on the modified second subtitle when the subtitle images stored in the memory do not comprise the first subtitle image.

15. The device of claim 1, wherein before the determining a modified second subtitle in response to modification of a second subtitle in a first subtitle, the method further comprises:
acquiring at least one first audio in the first video, wherein the at least one first audio comprises at least one selected from the group consisting of: audio of a video clip in the first video, audio of an effect used in the first video, and audio added to the first video; and
determining the first subtitle based on the at least one first audio.

16. The device of claim 15, wherein the determining the first subtitle based on the at least one first audio comprises:
generating the first subtitle based on the at least one first audio when the number of the at least one first audio is 1; and
determining a second audio with a largest volume from the at least one first audio, and generating the first subtitle based on the second audio when the number of the at least one first audio is greater than 1.

17. A non-transitory computer-readable storage medium, wherein a computer-executable instruction is stored in the computer-readable storage medium, and when the computer-executable instruction is executed by a processor, a method for processing subtitle is implemented, wherein the method comprises:
determining a modified second subtitle in response to modification of a second subtitle in a first subtitle, wherein the first subtitle is a subtitle of a first video, and the second subtitle is a part to be modified in the first subtitle;
determining a first subtitle image for the modified second subtitle based on subtitle images stored in a memory, wherein the memory manages the subtitle images stored based on a first policy; and
processing a second subtitle image of the second subtitle in the first video based on the first subtitle image to obtain a second video.

18. The non-transitory computer-readable storage medium of claim 17, wherein the processing a second subtitle image of the second subtitle in the first video based on the first subtitle image comprises:
acquiring a first type associated with the modified second subtitle, wherein the first type comprises at least one selected from the group consisting of: subtitle replacement, subtitle deletion, subtitle insertion, and subtitle addition; and
processing the second subtitle image based on the first type and the first subtitle image.

19. The non-transitory computer-readable storage medium of claim 18, wherein the processing the second subtitle image based on the first type and the first subtitle image comprises:
replacing the second subtitle image with the first subtitle image when the first type is the subtitle replacement or the subtitle deletion;
inserting the first subtitle image in a first period of time of the first video when the first type is the subtitle insertion, wherein the first period of time is a period of time in which the second subtitle image is displayed in the first video; and
determining a second period of time for adding the modified second subtitle, and adding the first subtitle image in the second period of time when the first type is the subtitle addition.

20. The non-transitory computer-readable storage medium of claim 17, wherein the determining a first subtitle image for the modified second subtitle based on subtitle images stored in a memory comprises:
determining whether the subtitle images stored in the memory comprise the first subtitle image;
acquiring the first subtitle image based on the subtitle images stored in the memory when the subtitle images stored in the memory comprise the first subtitle image; and
generating the first subtitle image based on the modified second subtitle when the subtitle images stored in the memory do not comprise the first subtitle image.
